(19) United States
(12) Patent Application Publication
(10) Pub. No.: US 2016/0121304 A1
(43) Pub. Date: May 5, 2016

(54) Sulfur Resistance of Zero-PGM for Diesel Oxidation Application

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTI, Ventura, CA (US)

(21) Appl. No.: 14/527,494

(22) Filed: Oct. 29, 2014

(51) Int. Cl. B01J 23/656

(52) U.S. Cl. CPC B01J 23/6562

(57) ABSTRACT

Sulfur tolerant oxidation catalysts with significant oxidation capabilities are disclosed. A plurality of catalyst samples may be prepared including ZPGM material compositions of YMnO₃ perovskite, CuₓMn₃₋ₓO₄ spinel, and a combination of both, supported on doped Zirconia and cordierite substrate, and front zoned with sulfur getters of Pd, Ba acetate, and Ce nitrate. Testing of samples may be performed under standard and sulfated DOC conditions to assess influence of adding front zoned sulfur getters to ZPGM catalyst samples. Levels of NO oxidation and HC conversion may be compared, and resistance to sulfur and catalytic stability may be observed to determine ZPGM samples zoned with sulfur getter which may provide the most significant improvements in NO oxidation, HC conversion, CO selectivity, and resistance to sulfur for use in DOC applications.

### CROSS-REFERENCE TO RELATED APPLICATIONS

The present disclosure is related to U.S. non-provisional patent application US 2013/0236380 A1 entitled “Palladium solid solution catalyst and methods of making”, invented by Stephen J. Golden, Randalph Hatfield, Jason D. Pless, and Johnny T. Ngo.

### BACKGROUND

1. Field of the Disclosure

This disclosure relates generally to catalyst materials for diesel oxidation applications, and more particularly, to non-PGM catalytically active material compositions integrated with a sulfur getter for reduction of emissions from a plurality of diesel engine systems.

2. Background Information

Sulfur oxides (SO_{X}) in a diesel engine exhaust are one of the major factors contributing toward catalyst poisoning and deactivation in aftertreatment catalysts. Interactions of SO_{X} with the catalyst metals and supports can result in sulfate formation. Oxidation of sulfur dioxide (SO₂) to sulfur trioxide (SO₃) with the subsequent formation of sulfuric acid (H₂SO₄) may be the most important of these processes. The SO₂, SO₃, and particulates including H₂SO₄ may chemisorb as sulfur species including various sulfates and sulfites onto the PGM and other catalysts that may be contained in the DOC materials. The relatively strong metal-sulfur bonds formed through such chemisorption enables the deposited sulfur species to block active catalytic sites and progressively diminish the catalytic conversion efficiency of the DOC. Additionally, sulfate particulates contribute to the total PM emissions from the engine.

Methodologies have been developed for the removal of deposited sulfur species from the DOC materials, but have been proven to be sort of burdensome because of the effect they tend to have on the fuel economy of the diesel engine, notwithstanding that DOC formulations are optimized to minimize generation of sulfate particulates in applications with sulfur-containing fuels and for the reduction of diesel PMs. Challenges of incorporating sulfur-based deactivation in DOC design may provide potential directions leading into the development of sulfur resistant materials for DOCs.

As emissions regulations become more stringent, there is significant interest in developing DOCs with improved properties for effective utilization and particularly with improved activity, and controlled sulfation to increase sulfur resistance. The continuing goal is to develop DOC systems including catalyst composites that provide improved performance in removal of residual hydrocarbons, carbon monoxide, NO_{X}, and PM including sulfates. Additionally, as emission standards tighten and PGMs become scarce with small market circulation volume, constant fluctuations in price, and constant risk to stable supply, amongst others, there is an increasing need for new compositions for DOC applications which may not require PGM and may exhibit improved catalytic behavior yielding enhanced activity and performance under diesel oxidation condition. There also remains a need for methods of producing such DOC formulations using the appropriate metal loadings of non-PGM material for catalyst architectures which may provide advanced DOC light-off and sulfur resistance of DOCs. In addition, it is desirable to refine zone-coating technologies and evaluate placement of particular catalytic or sulfur adsorbent compositions along the catalyst's length and radius.

According to the foregoing, it is desirable to improve zone-coating and assess placement of a particular catalyst material compositions along the catalyst configurations. There may be a need to provide catalytic properties which may significantly depend on active material compositions to obtain, under some conditions, high dispersion metal components systems for PGM-free catalyst systems which may be manufactured cost-effectively, such that performance may be improved by realizing suitable PGM-free catalytic layers in DOCs.

### SUMMARY

For diesel oxidation catalysts (DOCs), in a highly dispersed and active form aiming at improving conversion efficiency, a more effective utilization of PGM-free catalyst materials may be achieved. A plurality of coating process techniques may be employed for the incorporation of catalytically active species onto DOC system configurations. Incorporation of combinations of catalytically active materials may follow configurations which may include at least a substrate, a washchoat (WC) layer, and an impregnation (IMP) layer.

The present disclosure is directed to diesel oxidation catalyst (DOC) system configurations including Zero-PGM (ZPGM) catalysts combined with a sulfur getter to assist in the removal of sulfur species from the diesel engine out, and confirm that disclosed DOC formulations may be optimized to minimize generation of sulfate particulates from sulfur-containing fuels and for the reduction of PMs. The incorporation of sulfur-based deactivation in the design of DOC applications may provide development of sulfur resistant materials for DOC applications.

According to embodiments, a catalyst system may include at least a substrate and a WC layer, or at least a substrate, a WC layer, and an IMP layer. A plurality of catalyst systems may be configured to include WC layers of ZPGM catalytic material on support oxide, with selected base metal loadings; or a ZPGM-based IMP layer on a support oxide-based WC layer.

According to embodiments in present disclosure, ZPGM DOC catalyst systems may include a YMnO₃ perovskite structure prepared by incipient wetness (IW) technique on doped ZrO₂ for subsequent deposition on cordierite substrate.

According to other embodiments in present disclosure, the impregnation (IMP) technique may be used for applying an IMP layer including Cu_{1.0}Mn_{2.0}O₄ spinel on a WC layer of doped ZrO₂, subsequently deposited on cordierite substrate.

Yet in another embodiments, IW technique may be used to make powder form of a catalyst materials combination of YMnO₃ and Cu_{1.0}Mn_{2.0}O₄ spinel on doped Zirconia, subsequently applied as WC layer on cordierite substrate.

Embodiments in present disclosure may use catalyst zoning strategies for performance enhancement and sulfur resistance of ZPGM catalysts in DOC applications. In an aspect of the present disclosure, the catalyst systems for DOC application may include ZPGM samples configurations combined with a plurality of sulfur getters. The sulfur getters may include a cordierite substrate, a WC layer, and an IMP layer, where the WC layer may include alumina and OSM and an IMP layer of Barium acetate or Cerium nitrate. A PGM catalyst may also be used as reference sample sulfur getter combined with ZPGM catalyst. In present disclosure, the PGM catalyst may preferably be a Pd catalyst, which may be present in the IMP layer at a concentration of about 5 g/ft³ to about 100 g/ft³, as provided in U.S. patent application US 2013/0236380 A1, entitled “Palladium solid solution catalyst and methods of making”.

In another aspect of present disclosure, sulfur resistance of ZPGM only catalyst samples and ZPGM combined with sulfur getter samples may be tested under isothermal DOC condition and sulfated DOC condition at space velocity (SV) of about 54,000 h⁻¹. Accordingly, NO oxidation and HC conversion may be determined and compared to confirm significant improvements in sulfur resistance. Comparisons in NO oxidation of sulfur getters may determine the effect of adding a front zoned sulfur getter to the Y—Mn perovskite structure under sulfated condition and may confirm the ZPGM configuration with significantly improved NO oxidation stability before and after sulfation.

Numerous other aspects, features, and benefits of the present disclosure may be made apparent from the following detailed description taken together with the drawing figures, which may illustrate the embodiments of the present disclosure, incorporated here for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 represents catalyst configurations for ZPGM catalyst test methodology. FIG. 1A shows a catalyst configuration for a 3″ long ZPGM catalyst sample and FIG. 1B depicts a catalyst configuration of zoned catalyst samples configured with a 1″ long sulfur getter and a 2″ long ZPGM catalyst sample, according to an embodiment.

FIG. 2 depicts catalyst configurations for control sample test methodology. FIG. 2A shows catalyst configuration for control samples configured with a 1″ long sulfur getter and a 2″ long blank of cordierite substrate, and FIG. 2B illustrates catalyst configuration for a control sample configured with a 1″ long blank of cordierite substrate and a 2″ long ZPGM catalyst sample, according to an embodiment.

FIG. 3 illustrates NO oxidation comparison for control samples and ZPGM samples combined with a sulfur getter, tested according to a DOC/sulfur test methodology employing a standard gas stream composition under isothermal DOC condition, at about 340° C. and space velocity (SV) of about 54,000 h⁻¹, according to an embodiment.

FIG. 4 illustrates NO oxidation comparison for ZPGM samples combined with a sulfur getter and ZPGM only catalyst samples, tested according to a DOC/sulfur test methodology employing a standard gas stream composition under isothermal sulfated DOC condition, adding to the gas stream a concentration of about 3 ppm of SO₂ for about 3 hours, at about 340° C. and SV of about 54,000 h⁻¹, according to an embodiment.

FIG. 5 depicts NO oxidation comparison and sulfur resistance for ZPGM samples combined with Pd, tested according to a DOC/sulfur test methodology employing a standard gas stream composition under isothermal standard and sulfated DOC conditions, at about 340° C. and SV of about 54,000 h⁻¹, according to an embodiment.

FIG. 6 depicts HC conversion comparison for ZPGM samples combined with a sulfur getter and ZPGM only catalyst samples, tested according to a DOC/sulfur test methodology employing a standard gas stream composition under isothermal sulfated DOC condition, at about 340° C. and SV of about 54,000 h⁻¹, according to an embodiment.

FIG. 7 depicts the influence in NO oxidation and sulfur resistance of ZPGM with YMnO₃ perovskite structures and different types of front zone sulfur getters under isothermal DOC conditions before and after adding SO₂, at about 340° C. and SV of about 54,000 h⁻¹, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Catalyst” refers to one or more materials that may be of use in the conversion of one or more other materials.

“Platinum group metals (PGM)” refers to platinum, palladium, ruthenium, iridium, osmium, and rhodium.

“Zero platinum group (ZPGM) catalyst” refers to a catalyst completely or substantially free of platinum group metals.

“Catalyst system” refers to any system including a catalyst, such as a Platinum Group Metal (PGM) catalyst, or a Zero-PGM (ZPGM) catalyst a system, of at least two layers including at least one substrate, a washcoat, and/or an overcoat.

“Diesel oxidation catalyst” refers to a device which utilizes a chemical process in order to break down pollutants from a diesel engine or lean burn gasoline engine in the exhaust stream, turning them into less harmful components.

“Oxygen storage material (OSM)” refers to a material/composition able to take up oxygen from oxygen rich streams and able to release oxygen to oxygen deficient streams, thus buffering a catalyst system against the fluctuating supply of oxygen to increase catalyst efficiency.

“Support oxide” refers to porous solid oxides, typically mixed metal oxides, which are used to provide a high surface area which aids in oxygen distribution and exposure of catalysts to reactants such as NOₓ, CO, and hydrocarbons.

“Perovskite” refers to a ZPGM catalyst, having ABO₃ structure of material which may be formed by partially substituting element “A” and “B” base metals with suitable non-platinum group metals.

“Sulfur getter” refers to material that can store sulfur and may retard the sulfur poisoning and deactivation of a catalyst system.

“Spinel” refers to any of various mineral oxides of magnesium, iron, zinc, or manganese in combination with aluminum, chromium, copper or iron with AB₂O₄ structure.

“Conversion efficiency” refers to the percentage of emissions passing through the catalyst that are converted to their target compounds.

“Poisoning or catalyst poisoning” refers to the inactivation of a catalyst by virtue of its exposure to lead, phosphorus, or sulfur in an engine exhaust.

### DESCRIPTION OF THE DRAWINGS

Embodiments of the present disclosure may use of catalyst zoning strategies to enhance performance and sulfur resistance of ZPGM catalysts in diesel engine applications. The present disclosure is directed to diesel oxidation catalyst (DOC) system configurations including Zero-PGM (ZPGM) catalysts combined with sulfur getters, using methodologies which may assist in the removal of sulfur species from the diesel engine out, and confirm that disclosed DOC formulations may lead into the development of sulfur resistant materials for DOC applications.

Catalyst Structures for Analysis of ZPGM Zoning Strategies

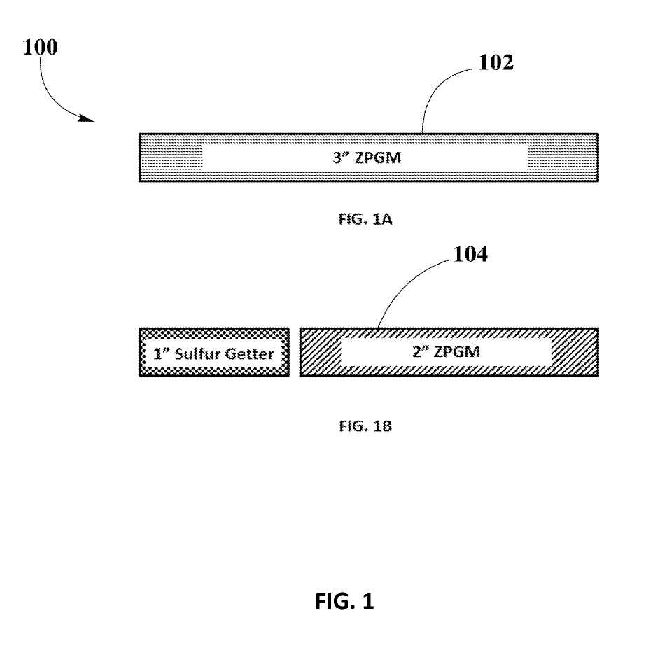

FIG. 1 represents catalyst structures 100 for ZPGM DOC catalyst samples for catalyst test methodology. FIG. 1A shows catalyst structure 102 for a 3″ long ZPGM catalyst sample, here identified as catalyst sample Type 1. FIG. 1B depicts catalyst structure 104 including zoned catalyst samples configured with a 1″ long sulfur getter and a 2″ long ZPGM catalyst sample, here identified as catalyst sample Type 2. All samples may have 1″ diameter.

Configuration, Material Composition, and Preparation of ZPGM Catalyst Zoned with Sulfur Getter

According to embodiments in present disclosure, a plurality of catalyst systems may be configured to include WC layers of ZPGM catalyst material on doped support oxide, with selected base metal loadings, coated on cordierite substrate; and/or a ZPGM-based IMP layer on a doped support oxide WC layer, with selected base metal loadings, coated on cordierite substrate.

ZPGM catalyst samples may be prepared including a WC layer of ZPGM material compositions such as YMnO₃ perovskite, CuₓMn₃₋ₓO₄ spinel, or a combination of YMnO₃ perovskite and CuₓMn₃₋ₓO₄ spinel, amongst others, supported on cordierite substrate.

Preparation of powder of YMnO₃ on doped ZrO₂ for WC layer may start by preparing a Y—Mn solution mixing the appropriate amount of Y nitrate solution and Mn nitrate solution with water to make solution at appropriate molar ratio. Then, the Y—Mn solution may be added to Pr₆O₁₁—ZrO₂ powder by IW technique. Subsequently, mixture powder may be dried and calcined at about 700° C. for about 5 hours, and then ground to fine grain for bulk powder. Bulk powder of YMnO₃/Pr₆O₁₁—ZrO₂ may be milled with water separately to make slurry, then coated on cordierite substrate and calcined at 700° C. for about 5 hours.

Coating process including impregnation (IMP) technique may be employed for an IMP layer of Cu_{1.0}Mn_{2.0}O₄ spinel, on WC layer of Pr₆O₁₁—ZrO₂. Preparation of the WC layer may start by milling Pr₆O₁₁—ZrO₂ with water separately to make slurry. Suitable loading of Pr₆O₁₁—ZrO₂ may be about 120 g/L. Then, Pr₆O₁₁—ZrO₂ slurry may be coated on cordierite substrate and calcined. Subsequently, for Cu_{1.0}Mn_{2.0}O₄ spinel, Cu—Mn solution may be prepared by mixing the appropriate amount of Mn nitrate solution and Cu nitrate solution with water to make solution at appropriate molar ratio. Then, Cu—Mn solution may be impregnated to WC layer, followed by calcination at 600° C. for about 5 hours.

IW technique may be employed for bulk powder of YMnO₃ and Cu_{1.0}Mn_{2.0}O₄. Preparation of the WC layer may start by preparing a Y—Cu—Mn solution mixing the appropriate amount of Y nitrate solution, Cu nitrate, and Mn nitrate solution with water to make solution at appropriate molar ratio of about 37% by mol of Y, about 8% by mol of Cu, and about 55% by weight of Mn to form Cu_{1.0}Mn_{2.0}O₄+YMnO₃. Then, the Y—Cu—Mn solution may be added to Pr₆O₁₁—ZrO₂ powder by IW method. Subsequently, mixture powder may be dried and calcined at about 700° C. for about 5 hours, and then ground to fine grain for bulk powder. Bulk powder of Cu_{1.0}Mn_{2.0}O₄+YMnO₃/Pr₆O₁₁—ZrO₂ may be milled with water separately to make slurry, then coated on cordierite substrate and subsequently calcined.

ZPGM catalyst samples may be cut in length of 3″ long, consider as catalyst sample Type 1 or length of 2″ long for downstream catalyst sample Type 2.

The sulfur getter in catalyst system of Type 2 may include a WC layer of PGM catalyst material such as Pd and OSM with Barium (Ba) and Cerium (Ce) supported on cordierite substrate. In present disclosure, the PGM catalyst may preferably be Pd, which may be present in the WC layer at a concentration of about 5 g/ft³ to about 100 g/ft³, preferably 20 g/ft³. The OSM may include zirconia, lanthanides, alkaline earth metals, transition metals, cerium oxide materials, or mixtures thereof. In this embodiment, OSM include Ba and Ce, which may help in retarding the poisoning and deactivation of the catalyst system by sulfur. The Pd sulfur getter may be prepared as described in U.S. Patent Application US 2013/0236380, incorporated here by reference. The Pd sulfur getter may be cut in 1″ length for placing upstream of ZPGM catalyst system, therefore the amount of PGM in full length of catalyst bed (3″) may be approximately about 6.6 g/ft³.

In another embodiment, sulfur getter may include an IMP layer of Ba acetate or Ce nitrate coated on WC layer of alumina and OSM. Preparation of the WC layer may start by milling alumina and OSM to make slurry. Suitable loading of alumina and OSM may be about 180 g/L. Alumina and OSM slurry may be subsequently coated on cordierite substrate and calcined. Subsequently, the solution of Ba acetate or Ce nitrate may be prepared and impregnated to WC layer and then calcined. OSM in WC layer may be Ce-, Zr-, or Pr-based materials. The Ce sulfur getter or Ba sulfur getter may be cut in 1″ length for placing upstream of ZPGM catalyst system.

Catalyst Structures for Control Samples in the Analysis of ZPGM Zoning Strategies

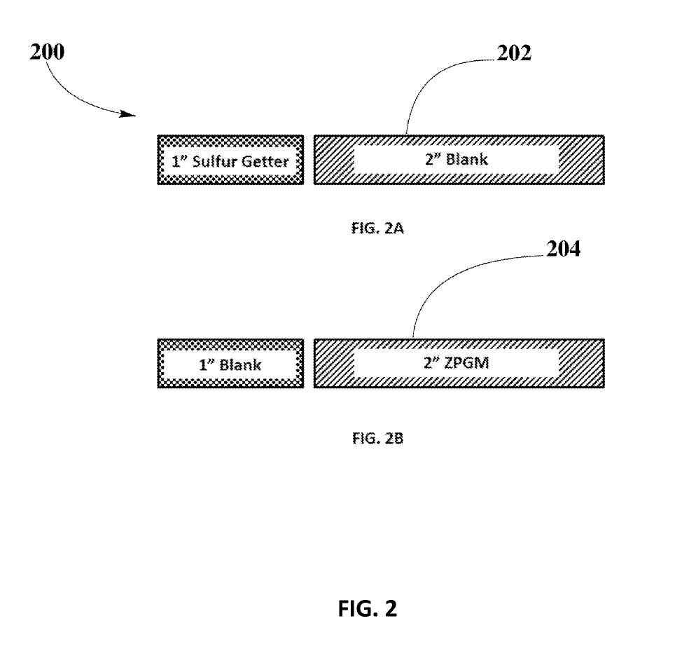

FIG. 2 depicts catalyst structures 200 for control samples used for catalyst test methodology. FIG. 2A shows catalyst structure 202 for control samples configured with a 1″ long sulfur getter and a 2″ long blank of cordierite substrate, here identified as control sample Type 3. FIG. 2B illustrates catalyst structure 204 for control samples configured with a 1″ long blank of cordierite substrate and a 2″ long ZPGM catalyst sample, here identified as control sample Type 4. All control samples may have 1″ diameter.

Catalyst samples Type 1 and Type 2, and control samples Type 3 and Type 4 may be tested under isothermal DOC condition and sulfated DOC condition. Performance in NO oxidation and HC conversion of samples may be determined and compared to confirm significant results of improved sulfur resistance, according to a DOC/sulfur test methodology.

DOC/Sulfur Test Methodology

DOC/sulfur test methodology may be applied to ZPGM catalyst systems and control samples as described in FIG. 1 and FIG. 2. The test methodology may enable confirmation of desirable and significant properties of the disclosed catalyst systems including ZPGM zoned with a sulfur getter for DOC applications.

Testing under steady state DOC condition may be performed isothermally at about 340° C. employing a flow reactor with flowing gas composition of about 100 ppm of NO, about 1,500 ppm of CO, about 4% of CO₂, about 4% of H₂O, about 14% of 0₂, and about 430 ppm of C₃H₆, at space velocity (SV) of about 54,000 h⁻¹. For isothermal sulfated DOC condition, a concentration of about 3 ppm of SO₂ may be added to the gas stream for about 3 hours.

Embodiments in present disclosure may use catalyst zoning strategies, specifically front zoning strategies. The effect of front zoning may be analyzed using the test methodology and may explain improvements in CO selectivity, NO conversion stability, and sulfur resistance of zoned ZPGM catalysts.

Analysis of Improving Sulfur Resistance of ZPGM Catalyst Samples

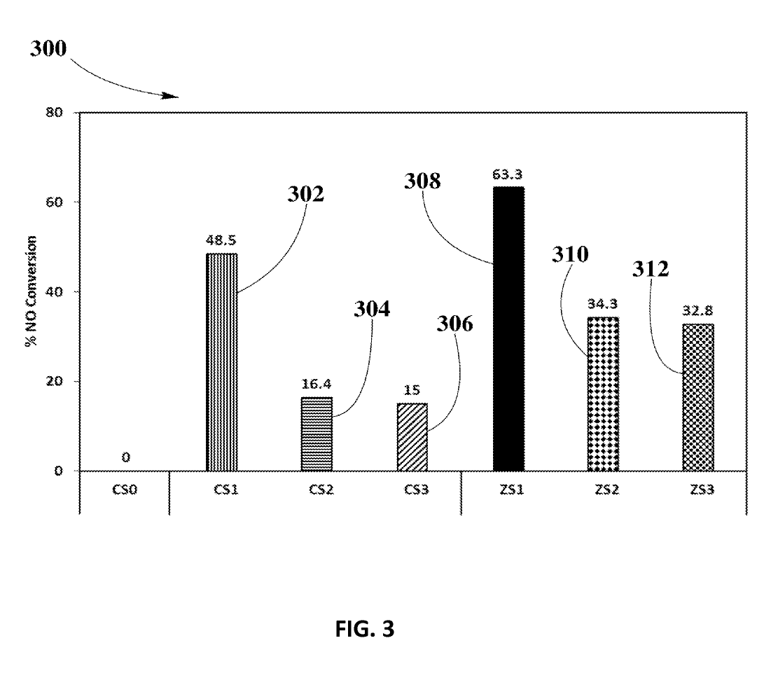

FIG. 3 illustrates a chart of NO oxidation comparison 300 for control samples and ZPGM samples combined with a sulfur getter, tested according to a DOC/sulfur test methodology employing a standard gas stream composition under isothermal DOC condition, at about 340° C. and space velocity (SV) of about 54,000 h⁻¹, according to an embodiment.

CSO is a control sample Type 3 with a 1″ Pd catalyst as sulfur getter combined with 2″ blank cordierite; CS1, CS2, and CS3 are catalyst control samples Type 4 with 1″ of blank cordierite and 2″ of YMnO₃ perovskite, Cu_{1.0} Mn_{2.0}O₄ spinel, and Cu_{1.0}Mn_{2.0}O₄+YMnO₃, respectively; and ZS1, ZS2, and ZS3 are ZPGM catalyst system of Type 2 including a 1″ Pd sulfur getter and 2″ ZPGM catalyst of YMnO₃, Cu_{1.0}Mn_{2.0}O₄ spinel, and Cu_{1.0}Mn_{2.0}O₄+YMnO₃, respectively.

As may be seen in NO oxidation comparison 300, CS0 does not present any NO conversion at 340° C., showing that Pd sulfur getter with lots of OSM and Ba/Ce is not active for NO oxidation at 340° C. Bar 302 shows 48.5% NO conversion for CS1, bar 304 shows 16.4% NO conversion for CS2, and bar 306 shows 15% NO conversion for CS3. Bar 308 depicts a 63.3% NO conversion for ZS1, bar 310 depicts 34.3% NO conversion for ZS2, and bar 312 depicts 32.8% NO conversion for ZS3.

As seen, under isothermal DOC condition, by comparing CS1 and ZS1, the NO conversion improved from 48.5% to 63.3% by adding Pd sulfur getter front zoned to YMnO₃ catalyst samples. By comparing CS2 and ZS2, the NO conversion improved from 16.4% to 34.3% by adding the Pd sulfur getter front zoned to Cu_{1.0}Mn_{2.0}O₄ catalyst samples; and by comparing CS3 and ZS3, the NO conversion improved from 15% to 32.8% by the effect of adding the Pd sulfur getter front zoned to Cu_{1.0}Mn_{2.0}O₄+YMnO₃ catalyst sample. These results show significant improvement of NO oxidation at 340° C. by combining ZPGM catalyst with a Pd catalyst front zone, regardless of type of ZPGM, in which ZPGM can have perovskite structure, spinel structure or a mixed phase of perovskite and spinel. The Pd front zoned may be applied in a single bed ZPGM catalyst with a front coating of Pd continued by ZPGM material.

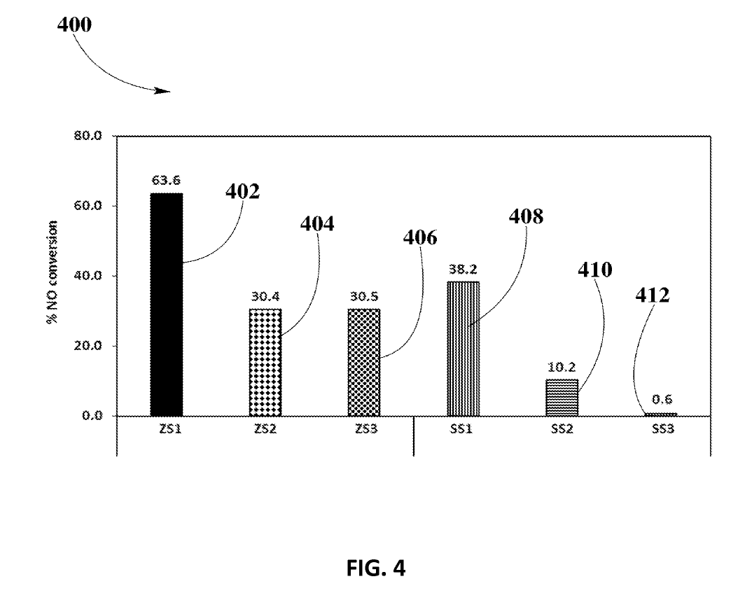

FIG. 4 illustrates a chart of NO oxidation comparison 400 for ZPGM catalyst samples of Type 1 and Type 2, tested according to a DOC/sulfur test methodology employing a standard gas stream composition under isothermal sulfated DOC condition using in the gas stream a concentration of about 3 ppm of SO₂ for about 3 hours, at about 340° C. and SV of about 54,000 h⁻¹, according to an embodiment.

ZS1, ZS2, and ZS3 are ZPGM catalyst samples Type 2 including a 1″ sulfur getter of Pd and 2″ YMnO₃, Cu_{1.0}Mn_{2.0}O₄ spinel, and Cu_{1.0}Mn_{2.0}O₄+YMnO₃ catalysts, respectively. SS1, SS2, and SS3 are catalyst samples Type 1 including a 3″ YMnO₃, Cu_{1.0}Mn_{2.0}O₄ spinel, and Cu_{1.0}Mn_{2.0}O₄+YMnO₃ catalysts, respectively.

As may be seen in NO oxidation comparison 400, under sulfated DOC condition, bar 402 shows 63.6% NO conversion for ZS1, bar 404 shows 30.4% NO conversion for ZS2, and bar 406 shows 30.5% NO conversion for ZS3. Bar 408 depicts a 38.2% NO conversion for SS1, bar 410 depicts 10.2% NO conversion for SS2, and bar 412 depicts 0.6% NO conversion for SS3.

As seen, under isothermal sulfated DOC condition, by comparing SS1 with ZS1, the NO conversion improved from 38.2% in 3″ (perovskite) ZPGM only sample to 63.3% in 1″ Pd sulfur getter+2″ (perovskite) ZPGM catalyst, indicating that the sulfur resistance of YMnO₃ perovskite increased by adding Pd in front bed. By comparing SS2 with ZS2, the NO conversion improved from 10.2% in 3″ (spinel) ZPGM only catalyst to 30.4% in 1″ Pd sulfur getter+2″ spinel ZPGM catalyst, indicating that the sulfur resistance of Cu_{1.0}Mn_{2.0}O₄ spinel increased by adding Pd in front bed. By comparing SS3 with ZS3, the NO conversion improved from 0.6% in 3″ (perovskite+spinel) ZPGM only catalyst to 30.5% in 1″ Pd sulfur getter+2″ (perovskite+spinel) ZPGM catalyst, indicating that the sulfur resistance of YMnO₃+Cu_{1.0}Mn_{2.0}O₄ increased by adding Pd in front bed.

As seen in FIG. 4, after sulfation of the catalyst, a significant improvement in NO oxidation may be realized by combining ZPGM catalyst with a Pd front zone, regardless of type of ZPGM catalyst, in which the ZPGM catalyst may have perovskite structure, spinel structure or a mixed phase of perovskite and spinel. The Pd front zoned can be applied in a single bed ZPGM catalyst with a front coating of Pd continued by ZPGM material. Combination of ZPGM with Pd front zone improves selectivity to CO, which helps improvement in NO conversion of ZPGM after sulfation. Additionally, ZPGM catalyst samples of YMnO₃ perovskite (SS1) also registered the highest level of NO conversion when compared with the other ZPGM structures, such as spinel or mixed phase of spinel and perovskite.

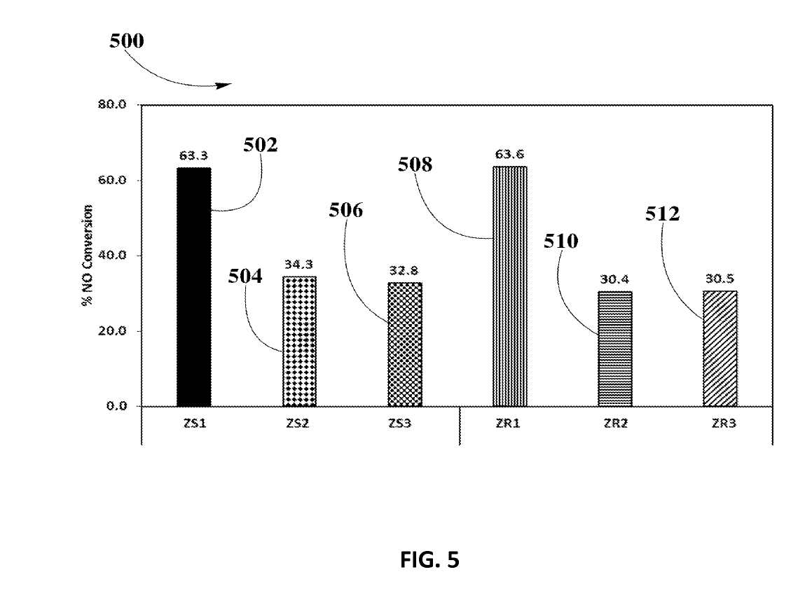

FIG. 5 depicts a chart of NO oxidation comparison 500 and sulfur resistance for ZPGM samples combined with Pd, tested according to a DOC/sulfur test methodology under isothermal standard and sulfated DOC conditions, at about 340° C. and SV of about 54,000 h⁻¹, according to an embodiment.

ZS1, ZS2, and ZS3 are ZPGM catalyst samples Type 2 as described in FIG. 4 under isothermal DOC gas composition at 340° C. before adding SO₂ to the gas stream. ZR1, ZR2, and ZR3 are in fact the same as ZS1, ZS2, and ZS3, respectively after adding SO₂ to the gas stream.

As may be seen in NO oxidation comparison 500, under isothermal DOC conditions at 340° C., bar 502 shows 63.3% NO conversion for ZS1, bar 504 shows 34.3% NO conversion for ZS2, and bar 506 shows 32.8% NO conversion for ZS3. Under isothermal sulfated DOC conditions at 340° C., bar 508 depicts a 63.6% NO conversion for ZR1, bar 510 depicts 30.4% NO conversion for ZR2, and bar 512 depicts 30.5% NO conversion for ZR3.

By comparing NO conversion of ZPGM catalyst systems before and after sulfation at 340° C., it may be noticed that there is a significant resistance to sulfur, regardless of type of ZPGM, in which ZPGM may have perovskite structure, spinel structure or a mixed phase of perovskite and spinel. ZPGM catalyst of Type 2, in which the Pd front zone may be applied to ZPGM catalyst, provides significantly stable NO conversion before and after sulfation. As seen, the effect of adding the front zone Pd sulfur getter and the resistance to sulfur may be verified by the resulting NO conversion levels, which practically remain constant before and after sulfation. The most significant effect of adding the front zone of Pd was registered for the YMnO₃ perovskite catalyst samples.

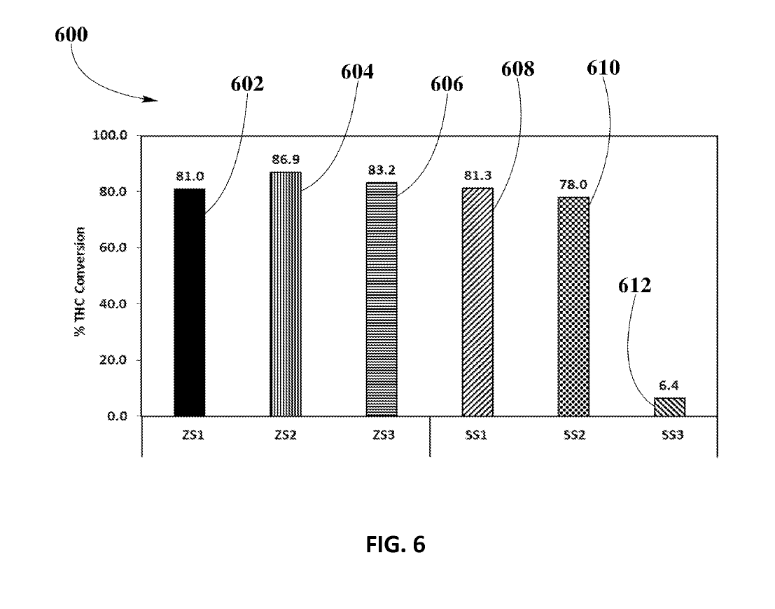

FIG. 6 depicts a chart of HC conversion comparison 600 for ZPGM catalyst samples of Type 1 and Type 2, tested according to a DOC/sulfur test methodology employing a standard gas stream composition under isothermal sulfated DOC condition using in the gas stream a concentration of about 3 ppm of SO₂ for about 3 hours, at about 340° C. and SV of about 54,000 h⁻¹, according to an embodiment.

ZS1, ZS2, and ZS3 are catalyst samples Type 2, and SS1, SS2, and SS3 are catalyst samples Type 1, as described in FIG. 4.

As may be seen in HC conversion comparison 600, under sulfated DOC condition, bar 602 shows 81.0% HC conversion for ZS1, bar 604 shows 86.9% HC conversion for ZS2, and bar 606 shows 83.2% HC conversion for ZS3. Bar 608 depicts 81.3% HC conversion for SS1, bar 610 depicts 78.0% HC conversion for SS2, and bar 612 depicts 6.4% HC conversion for SS3.

As seen, under isothermal sulfated DOC condition at about 340° C., by comparing SS1 with ZS1, the HC conversion is about 81.3% in 3″ (perovskite) ZPGM only catalyst and about 81% in 1″ Pd sulfur getter+2″ (perovskite) ZPGM catalyst, indicating that the resistance of HC conversion in YMnO₃ perovskite does not change by adding Pd in front bed. By comparing SS2 with ZS2, the HC conversion improved from 78.0% in 3″ (spinel) ZPGM only catalyst to 86.9% in 1″ Pd sulfur getter+2″ spinel ZPGM catalyst, indicating that the resistance of HC conversion in Cu_{1.0}Mn_{2.0}O₄ spinel increased by adding Pd in front bed. By comparing SS3 and ZS3, the HC conversion improved from 6.4% in 3″ (perovskite+spinel) ZPGM catalyst to 83.2% in 1″ Pd sulfur getter+2″ (perovskite+spinel) ZPGM catalyst, indicating that the resistance of HC conversion in YMnO₃+Cu_{1.0}Mn_{2.0}O₄ increased by adding Pd in front bed.

After sulfation of the catalyst, a significant improvement in HC oxidation may be observed by combining ZPGM catalyst with a Pd front zone, in which ZPGM catalyst may have spinel structure or a mixed phase of perovskite and spinel. After sulfation, HC conversion of ZPGM with perovskite structure is stable and Pd front zone does not change the level of HC oxidation. The Pd front zone may be applied in a single bed ZPGM catalyst with a front coating of Pd continued by ZPGM material. Combination of ZPGM with Pd front zone improves selectivity to CO, which helps improvement in HC conversion of ZPGM after sulfation.

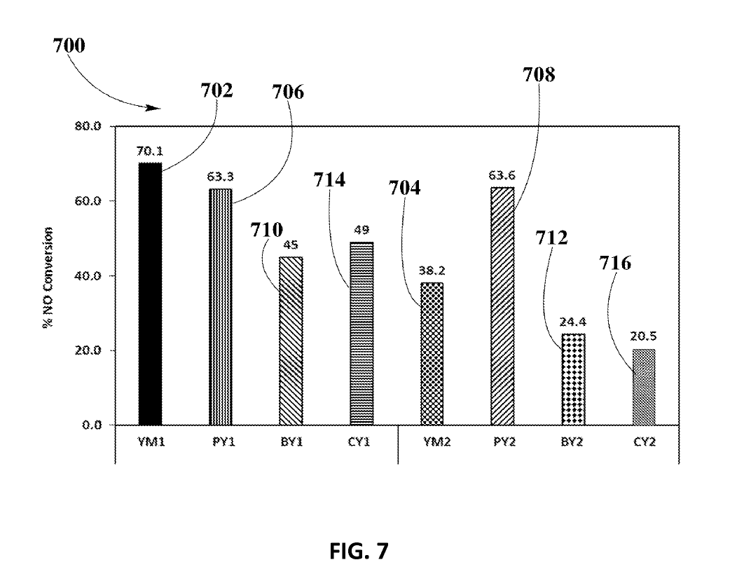

FIG. 7 depicts the influence in NO oxidation and sulfur resistance of ZPGM with YMnO₃ perovskite structures and different types of front zone sulfur getters under isothermal DOC conditions before and after adding SO₂, at about 340° C. and SV of about 54,000 h⁻¹, according to an embodiment.

In this embodiment NO oxidation comparison 700 may be performed for catalyst samples Type 1 and Type 2, as follows:

YM1 is a catalyst sample Type 1 including a 3″ ZPGM with YMnO₃ structure; PY1 is a catalyst sample Type 2 including a 1″ Pd sulfur getter and 2″ long YMnO₃ catalyst; BY1 is a catalyst sample Type 2 including a 1″ Ba sulfur getter and 2″ long YMnO₃ catalyst; and CY1 is a catalyst sample Type 2 including a 1″ Ce sulfur getter and 2″ long YMnO₃ catalyst. % NO oxidation shown for these catalyst samples are under DOC condition.

YM2, PY2, BY2, and CY2 are catalyst samples with same composition as described for YM1, PY1, BY1, and CY1 after adding SO₂ to gas stream. % NO oxidation shown for these catalyst samples are under sulfated DOC condition.

As may be seen in NO oxidation comparison 700, under standard DOC condition, bar 702 shows 70.13% NO conversion for YM1, but after about 3 hours with sulfur flowing with rate of about 3 ppm in the gas stream, NO conversion drops to 38.2%, as presented in bar 704 for YM2, showing the ZPGM with perovskite structure does not show resistance after sulfation. However, bar 706 shows 63.3% NO conversion for PY1 under standard DOC condition, and after sulfation NO conversion retain at about 63.6%, as shown in bar 708 for PY2, indicating the effect of adding the front zoned Pd to YMnO3 perovskite increased the resistance to sulfur verified by the resulting NO conversion levels, which practically remain constant before and after adding sulfur to the gas stream.

For catalyst samples including sulfur getters of Ba acetate, bar 710 shows 45% NO conversion for BY1 under standard DOC condition, but after sulfation NO conversion drops to 24.4%, as shown in bar 712 for BY2. For catalyst samples including sulfur getters of Ce nitrate under standard DOC condition, bar 714 shows 49% NO conversion for CY1, but after sulfation NO conversion drops to 20.5%, as shown in bar 716 for CY2.

The effect of adding the front zoned Pd sulfur getter to YMnO₃ catalyst samples and the resistance to sulfur may be verified by the resulting NO conversion levels, which practically remained constant before and after adding sulfur to the gas stream. YMnO₃ catalyst samples front zoned with Ba acetate and Ce nitrate may not be considered as solutions for improving sulfur resistance, as observed. ZPGM catalyst with YMnO₃ perovskite structure with the front zoned Pd registered a high significant effect and influence when combining the observed levels of NO oxidation, HC conversion, and resistance to sulfur. Although the Pd front zone with a concentration of about 6.67 gt/ft³ includes OSM with Ba and Ce, it has been verified that neither Ba nor a Ce may be main players in providing the significant improvements in sulfur resistance of ZPGM zoned with Pd. The Pd front zoned can be applied in a single bed ZPGM catalyst with a front coating of Pd continued by ZPGM material such as YMnO₃ perovskite. However, the Pd zone layer does not require including Ba or Ce.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst, comprising:
at least one zero platinum group metal (ZPGM) in combination with Pd, wherein the catalyst provides substantially constant NO conversion levels before and after sulfation.

2. The catalyst of claim 1, wherein the Pd is present in the front zone of a catalyst system.

3. The catalyst of claim 2, wherein a washcoat of the catalyst system comprises the front zone.

4. The catalyst of claim 1, wherein the catalyst is heated to about 340° C.

5. The catalyst of claim 1, wherein the ZPGM comprises one selected from the group comprising a perovskite structure, a spinel structure, or a mixed phase of perovskite and spinel.

6. The catalyst of claim 1, wherein the ZPGM catalyst comprises at least one perovskite structure having a general formula of YMnO₃.

7. The catalyst of claim 1, wherein the catalyst provides resistance to sulfur before and after sulfation.

8. The catalyst of claim 1, wherein NO conversion is greater than 60%.

9. A catalytic system, comprising:
a substrate;
an overcoat suitable for deposition on the substrate, comprising at least one first zero platinum group metal (ZPGM) catalyst; and
at least one washcoat suitable for deposition on the substrate, comprising at least one second ZPGM catalyst in combination with Pd;
wherein the at least one second ZPGM catalyst in combination with Pd is present in a front zone of the at least one washcoat and provides substantially constant NO conversion levels before and after sulfation.

10. The catalytic system of claim 9, wherein the washcoat comprises at least layer of at least one third ZPGM catalyst in a zone behind the front zone.

11. The catalyst system of claim 10, wherein the at least one third ZPGM catalyst comprises at least one perovskite structure having a general formula of YMnO₃.

12. The catalyst system of claim 9, wherein the front zone further comprises at least one selected from the group comprising an OSM, Ba, Ce, and combination thereof.

13. The catalyst system of claim 9, wherein the catalyst is heated to about 340° C.

14. The catalyst system of claim 9, wherein the catalyst provides resistance to sulfur before and after sulfation.

15. The catalyst system of claim 9, wherein NO conversion is greater than 60%.

16. The catalyst system of claim 9, wherein HC conversion is greater than 60%.
